(19) United States
(12) Patent Application Publication
(10) Pub. No.: US 2008/0113237 A1
(43) Pub. Date: May 15, 2008

(54) Power generating module and electronic device

(75) Inventors: Takashi Matsuda, Tokyo (JP); Hiroyasu Bitoh, Tokyo (JP); Masaharu Shioya, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/978,903

(22) Filed: Oct. 30, 2007

(30) Foreign Application Priority Data
Nov. 10, 2006 (JP) 2006-304801

(51) Int. Cl. H01M 8/04

(52) U.S. Cl. 429/22

(57) ABSTRACT

Disclosed is a power generating module which generates electric power by using fuel, including: an accommodating section to accommodate a fuel container to store fuel; a power generating section to perform power generation by using the fuel in the fuel container; and a controlling section to allow, after an amount of the fuel in the fuel container accommodated in the accommodating section becomes less than a predetermined amount necessary for the power generation in the power generating section, at least a portion of a by-product generated in a process of the power generation in the power generating section to be collected into the fuel container containing less than the predetermined amount of the fuel.

### BACKGROUND OF THE INVENTION

1. Field of the Invention

The present invention relates to a power generating module which generates electric power by being supplied with fuel from a fuel container and an electronic device.

2. Description of the Related Art

Lately, small electronic devices such as cellular phones, laptop computers, digital cameras, watches, and PDAs (Personal Digital Assistance) are achieving great advancements and developments. As power sources for electronic devices, primary cells such as alkaline cells and manganese cells or secondary cells such as nickel-cadmium cells, nickel-hydrogen cells and lithium ion cells are used. Lately, as an alternative to primary cells and secondary cells, the research and development of fuel cells, which enable high energy use efficiency, are being actively done.

A fuel cell is to convert chemical energy into electrical energy by an electrochemical reaction of fuel and oxygen in the air. Since fuel cells use an electrochemical reaction in which the chemical energy of the fuel is directly converted to electrical energy, water is produced and discharged as a by-product of the reaction.

For example, a fuel cell system of Japanese Patent Application Laid-open Publication No. 2004-192171, a cartridge for collecting water is separately provided as well as a fuel cartridge.

### SUMMARY OF THE INVENTION

As described above, when a cartridge for collecting water is provided separately from a fuel cartridge, the fuel cartridge and the cartridge to which water has collected needed to be changed separately.

The present invention has been made in consideration of the above situation, and is successful in providing a power generating module and an electronic device in which a by-product can be easily collected in a fuel container.

According to a first aspect of the present invention, there is provided a power generating module which generates electric power by using fuel, comprising:

an accommodating section to accommodate a fuel container to store fuel;

a power generating section to perform power generation by using the fuel in the fuel container; and

a controlling section to allow, after an amount of the fuel in the fuel container accommodated in the accommodating section becomes less than a predetermined amount necessary for the power generation in the power generating section, at least a portion of a by-product generated in a process of the power generation in the power generating section to be collected into the fuel container containing less than the predetermined amount of the fuel.

In the above-mentioned power generating module, the controlling section may allow the by-product collected in the fuel container to be supplied to the power generating section for the power generation in the power generating section.

The above-mentioned power generating module may further comprise a collector to collect the by-product generated by the power generation,

and the controlling section may allow a surplus portion of the by-product from the collector to be collected into the fuel container containing less than the predetermined amount necessary for the power generation.

In the above-mentioned power generating module, the fuel container containing less than the predetermined amount necessary for the power generation may be substantially empty.

The above-mentioned power generating module may further comprise a reacting section to reform the fuel of the fuel container.

In the above-mentioned power generating module, the controlling section prevents at least the portion of the by-product from being collected into the fuel container until the amount of the fuel in the fuel container becomes less than the predetermined amount.

An electronic device may comprise:

the above-mentioned power generating module.

According to a second aspect of the present invention, there is provided a power generating module which generates electric power by using fuel, comprising:

an accommodating section to accommodate a plurality of fuel containers to store fuel;

a power generating section to perform power generation by using the fuel in the fuel containers; and

a controlling section to allow, after an amount of the fuel in one of the plurality of fuel containers accommodated in the accommodating section becomes less than a predetermined amount necessary for the power generation in the power generating section, at least a portion of a by-product generated in a process of the power generation in the power generating section to be collected into the one of the plurality of fuel containers containing less than the predetermined amount of the fuel.

In the above-mentioned power generating module, the controlling section may allow the by-product collected in the fuel container to be supplied to the power generating section for the power generation in the power generating section.

The above-mentioned power generating module may further comprise a collector to collect the by-product generated by the power generation,

and the controlling section may allow a surplus portion of the by-product from the collector to be collected into the fuel container containing less than the predetermined amount necessary for the power generation.

In the above-mentioned power generating module, the fuel container containing less than the predetermined amount necessary for the power generation may be substantially empty.

The above-mentioned power generating module may further comprise a reacting section to reform the fuel of the fuel container.

In the above-mentioned power generating module, the controlling section prevents at least the portion of the by-product from being collected into any of the plurality of fuel containers until the amount of the fuel in one of the plurality of fuel containers becomes less than the predetermined amount.

An electronic device may comprise:

the above-mentioned power generating module.

### BRIEF DESCRIPTION OF THE DRAWINGS

The present invention will become more fully understood from the following detailed description with the accompanying drawings and are explanatory only, and thus are not intended as a definition of the limits of the present invention, and wherein;

FIG. 1 is an exploded perspective view of a fuel container 100;

FIG. 2A is a top view of the fuel container 100;

FIG. 2B is a sectional view taken along cross-section line II-II;

FIG. 3 is a block diagram showing a schematic structure of a power generating system 300;

FIG. 4 is a flow chart showing switching operation processing of a flow path switching section;

FIG. 5A is a top view of an electronic device 400;

FIG. 5B is a bottom view of the electronic device 400 of FIG. 5A;

FIG. 5C is a rear view of the electronic device 400 of FIG. 5A;

FIG. 6 is an exploded perspective view of a fuel container 500;

FIG. 7A is a top view of a fuel container 500;

FIG. 7B is a sectional view taken along cross-section line VII-VII;

FIG. 8A is a top view of the electronic device 800;

FIG. 8B is a right side view of the electronic device 800 of FIG. 8A; and

FIG. 8C is a rear view of the electronic device 800 of FIG. 8A.

### DESCRIPTION OF THE PREFERRED EMBODIMENTS

The best mode for carrying out the present invention will be explained below with reference to the drawings. The scope of the invention is not limited to the illustrated embodiments.

### First Embodiment

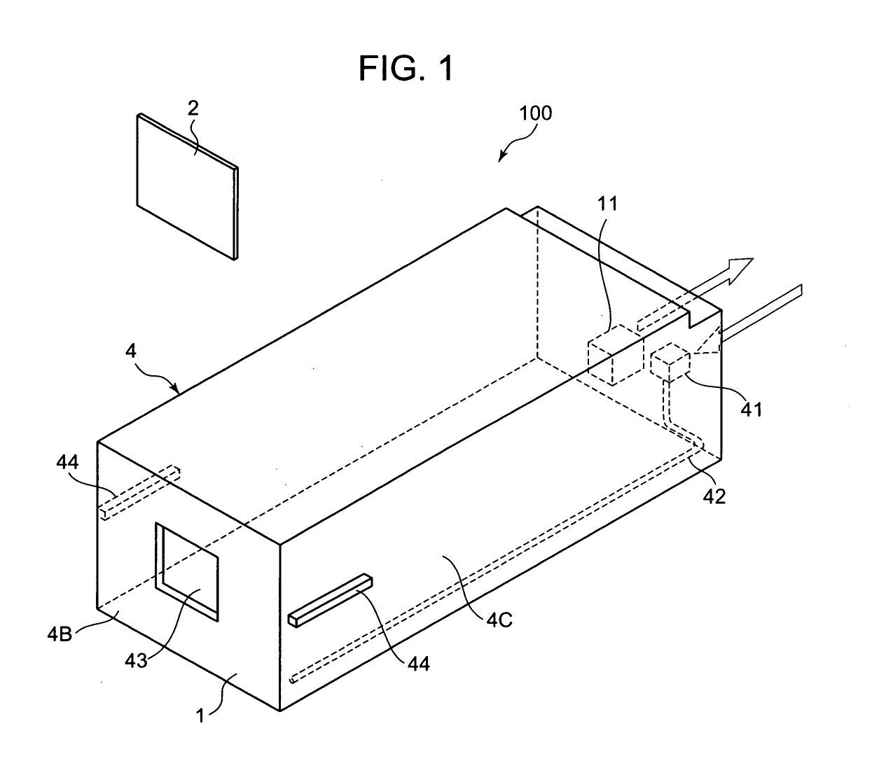

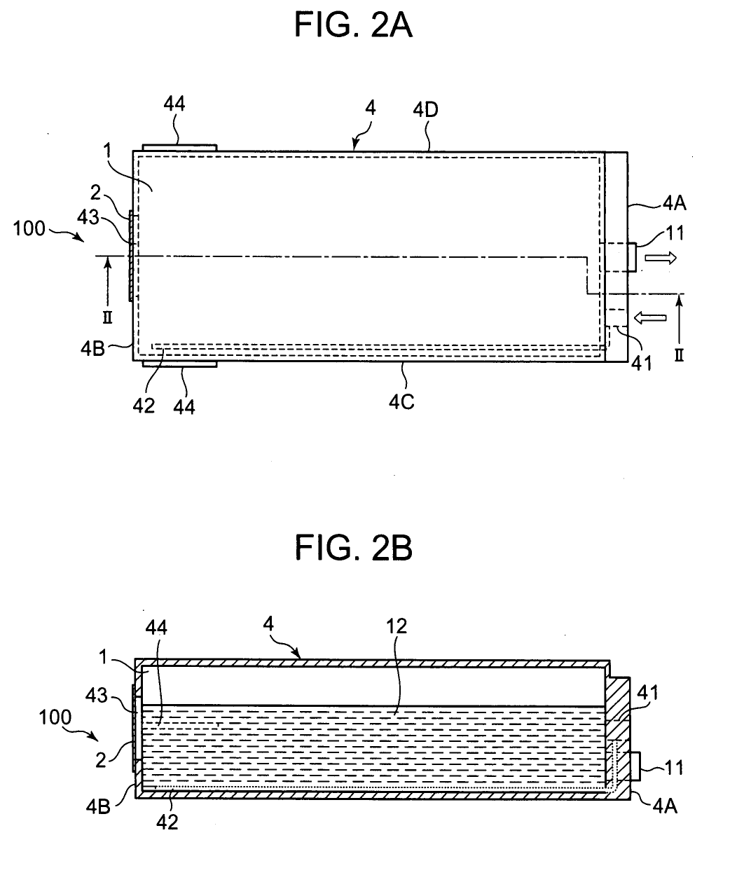

FIG. 1 is an exploded perspective view of a fuel container 100, FIG. 2A is a top view of the fuel container 100, and FIG. 2B is a sectional view taken along cross-section line II-II.

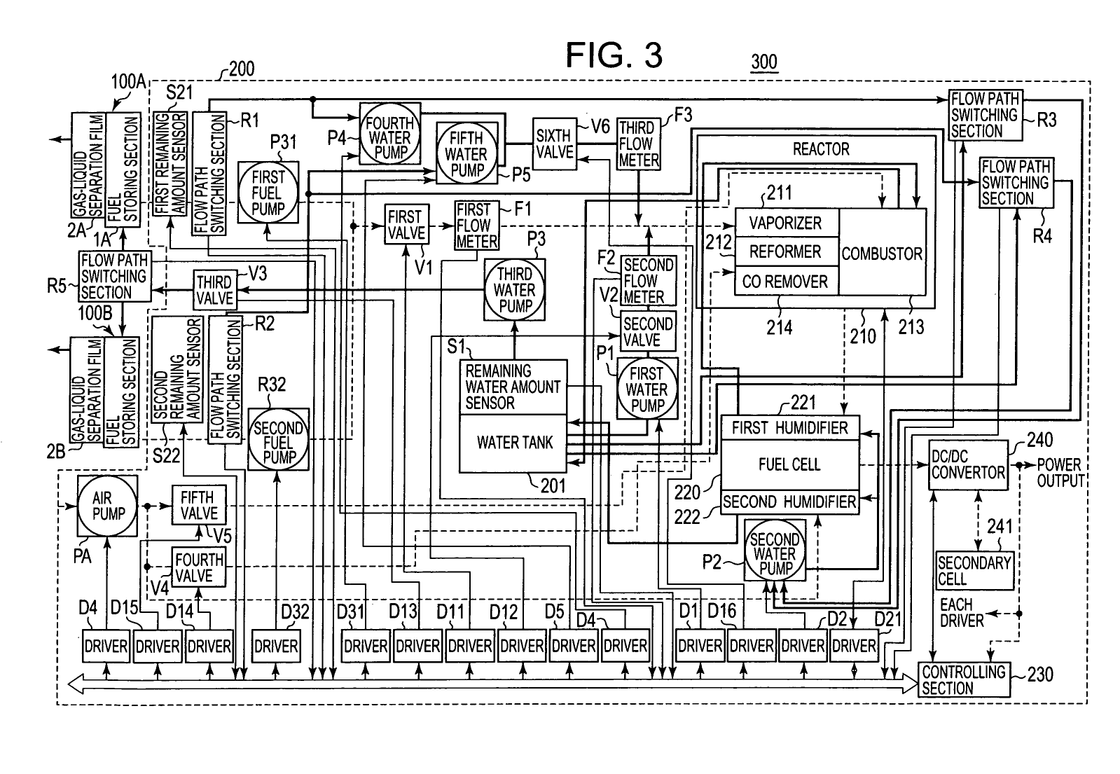

A fuel container 100 can be removably connected to a power generating module 200 (see FIG. 3) in the accommodating section of the power generating module 200 which accommodates the fuel container 100, and includes a fuel storing section 1 which stores fuel 12. The fuel storing section 1 cools and collects discharge including gas and water discharged from the power generating module 200 which generates power with the fuel 12 supplied from the fuel storing section 1.

The fuel storing section 1 is a box-shaped space which is formed in a box-shaped case 4. The fuel 12 is chemical fuel alone or a mixture of chemical fuel and water, and as chemical fuel, compounds including hydrogen atoms, for example, alcohols such as methanol, ethanol, etc., ethers such as dimethyl ether, etc., and gasoline may be used. In this embodiment, chemical fuel such as methanol is to be used. As mixtures of chemical fuel and water, for example, a uniform mixture of methanol and water is used as a chemical reaction material. The fuel storing section 1 is used as a water collecting section in order to collect water, which is a by-product, after finishing discharge of the fuel 12.

The case 4 is transparent or semitransparent and is, for example, made of a synthetic resin material, such as polyethylene, polypropylene, polycarbonate, and acryl.

On an end surface in a longitudinal direction of the case 4 (right end surface 4A in FIG. 2), a fuel discharge opening 11, which discharges the fuel 12 to the power generating module 200, is formed in a convex shape projecting outward from the right end surface 4A by penetrating the end surface 4A so as to be in communication with the inside of the fuel storing section 1.

The fuel discharge opening 11, which is provided at a cap of a convex projecting from the right end surface 4A of the case 4, is a through hole for discharging out the fuel 12 in the fuel storing section 1 and a check valve (not shown) is fitted therein for preventing the fuel from being discharged out through the fuel discharge opening 11 from the fuel storing section 11 unnecessarily. Concretely, the check valve is a duckbill valve formed in a duckbill shape with a material having flexibility and elasticity. The check valve is fitted in the fuel discharge opening 11 so that a tip end of the duckbill shape faces the inside of the fuel storing section 1. Examples of the material having flexibility and elasticity are ethylene propylene diene monomer rubber (EPDM) and butyl rubber. Generally, butyl rubber shows low gas permeability among elastic polymers and thus, it is preferable to select the butyl rubber in practical use in order to make a component smaller. Since the check valve does not have a mechanically complicated structure, the volume and cost thereof can be reduced. The check valve may be provided in advance with an insertion hole which communicates the inside and outside of the fuel storing section 1 when a needle-shaped fuel supply tube (not shown), which is provided in the later-described power generating module 200, is inserted in order to supply the fuel 12 from the fuel container 100. Alternatively, the insertion hole may be formed by inserting the fuel supply tube. When the insertion hole is provided in advance, the check valve is designed so that force is applied around the insertion hole in the direction of closing the insertion hole due to an internal pressure of the fuel 12 inside the fuel storing section 1 if the inside of the fuel storing section 1 is filled with fuel 12. Due to the restoring force by elasticity, the check valve is forced to return to its original shape, thus no gap is formed around the fuel supply tube inserted in the insertion hole. Consequently, no fuel leaks out of the fuel storing section 1 from the insertion hole unnecessarily. By inserting the fuel supply tube of the power generating module 200, the fuel 12 is discharged from the fuel storing section 1 to the power generating module 200 through the fuel discharge opening 11, and through the fuel supply tube.

A convex-shaped discharge collecting opening 41 which communicates with the inside of the fuel storing section 1 and collects the discharge which is discharged from the later-described power generating module 200 is provided in a buried manner on the right end surface 4A of the case 4 at the upper side of the fuel discharge opening 11.

The discharge collecting opening 41, which is provided at a cap of a convex projecting from the right end surface 4A of the case 4, is a through hole for collecting discharge into the fuel storing section 1 and check valve (not shown) is fitted therein so that once discharge is supplied to the inside of the case 4 through the discharge collecting opening 41, the discharge is prevented from being discharged out from the case 4 unnecessarily. Concretely, the same check valve as the check valve fitted in the above-described fuel discharge opening 11 may be used. A discharge sending tube 42 is provided in the discharge collecting opening 41 for supplying discharge into the fuel storing section 1 through the check valve. The discharge sending tube 42 is laid on the lower side from the discharge collecting opening 41 and extends toward a left end of the fuel storing section 1 along the longitudinal direction of the case 4.

A rectangular opening 43 which communicates to the inside of the fuel storing section 1 is formed on the other end surface (left end surface in FIG. 2) in the longitudinal direction of the case 4. A gas-liquid separation film 2 which includes a hydrophobic porous film with a gas-liquid separation function is attached so as to cover the opening 43. The gas-liquid separation film 2 which is permeable to gas but not permeable to liquid is a rectangular thin film and is made of polyethylene, polypropylene, polyacrylonitrile, polymethylmethacrylate, cellulosic resin such as cellulose acetate and cellulose triacetate, polysulfone resin such as polyether sulfone and polysulfone, etc. Thus, gas may pass between inside and outside of the case 4 through the gas-liquid separation film 2 but liquid may not pass through the gas-liquid separation film 2. Thus, water inside the case 4 does not leak outside. When water is collected into the case 4 as discharge from the discharge collecting opening 41, air inside the case 4 which corresponds to the collected water in volume is discharged outside through the gas-liquid separation film 2.

Guides 44 and 44 are attached to a front surface 4C and a rear surface 4D respectively at the left end side of the case 4 for removably attaching the case 4 to a later-described electronic device 400. The guides 44 and 44 extend on the front surface 4C and the rear surface 4D straight in a horizontal direction.

The fuel 12 inside the fuel storing section 1 of the above-described fuel container 100 is supplied to the later-described power generating module 200 through the fuel discharge opening 11 and the fuel 12 is used to generate electric energy. When the fuel 12 in the fuel storing section 1 runs out, the discharge which is produced in the power generating module 200 is sent through the discharge collecting opening 41 to the discharge sending tube 42, then flows through the discharge sending tube 42 to be sent to the fuel storing section 1. The water vapor in the gas of the discharge is cooled while flowing in the discharge sending tube 42, or cooled by the collected water in the fuel storing section 1 and is condensed to water, and thus collected in the fuel storing section 1. The gas which was not condensed is released outside through the gas-liquid separation film 2 and the condensed water, since it is liquid, cannot pass through the gas-liquid separation film 2 and is accumulated in the fuel storing section 1.

FIG. 3 is a block diagram showing a schematic structure of a power generating system 300 comprising a first fuel container 100A and a second fuel container 100B which have the same structure as the above described fuel container 100 and a power generating module 200. In the description below, each component comprising the first fuel container 100A corresponds to each component of the above described fuel container 100, thus the letter A will be applied to the same reference numerals, and as for the second fuel container 100B, the letter B will be applied to the same reference numerals.

The power generating system 300 comprises an accommodating section which accommodates a first fuel container 100A and a second fuel container 100B, and a power generating module 200 which generates power by the fuel 12 supplied from the first and second fuel containers 100A and 100B. In the power generating system 300, the power generating module 200 generates power by taking in the fuel 12 from either one of the fuel containers 100A and 100B selected from the first and second fuel containers 100A and 100B. When the power generating module 200 generates power, the power generating module 200 continues to take in the fuel 12 until the selected fuel container 100A or 100B becomes empty, and when the selected container becomes empty then switches and takes in the fuel 12 from the other fuel container 100A or 100B. The power generating module 200 which has taken in the fuel 12 discharges water, and the water is collected in the water tank (collector) 201 in the power generating module 200. The water tank 201 has an acceptable amount which can store not less than the amount of water generated and discharged by the amount of the fuel 12 when at least one fuel container 100A or 100B is full. Thus when the water collected by the water tank 201 is a predetermined amount (for example, 50 ml) or more and less than the acceptable amount (for example, 70 ml), either one of the fuel containers 100A or 100B is surely empty of the fuel 12. At this time, the surplus water in the water tank 201 after deducting the amount of water necessary for the vaporizer 211 at starting up and the amount of water necessary for the first humidifier 221 and the second humidifier 222 to humidify at starting up (for example 10 ml) is collected in the fuel storing section (1A or 1B) of the fuel container (100A or 100B) which is empty of the fuel 12 and the amount of water in the water tank 201 is controlled so as to include the amount necessary at starting up. The control may be done so that the water collected in the fuel storing section (1A or 1B) is reused for power generation.

The power generating module 200 comprises a water tank 201 which stores water, a reactor 210 which generates hydrogen from the fuel 12 supplied from the first and second fuel containers 100A and 100B and the water supplied from the water tank 201, and a power generating section 220 which includes a fuel cell which generates electric energy by electrochemical reaction of hydrogen. The power generating module 200 also comprises a first humidifier 221 which humidifies the hydrogen generated in the reactor 210 and supplies the hydrogen to the anode of the power generating section 220 and a second humidifier 222 to humidify air supplied to the cathode of the power generating section 220. The electrolyte film of the power generating section 220 is in a humidified state by the air and reformed gas humidified by the first humidifier 221 and the second humidifier 222. It is preferable that the timing of beginning the supply of water to the first humidifying section 221 and the second humidifying section 222 is just before the power generating section 220 starts generating power, and the period of supplying water may be during the power generation of the power generating section 220 or if the water generated when the power generating section 220 generates power permeates the entire electrolyte film, the water may be supplied only just before the start of the power generation.

In the water tank 201, water is stored and the later-described first water pump P1 and the second water pump P2 supplies the stored water to the vaporizer 211 of the reactor 210 and to the first and second humidifiers 221 and 222. As described later, the discharge (water) which is discharged from the cathode of the power generating section 220 is stored in the water tank 201. The surplus water of the power generating section 220 which was not humidified and discharged by the first and second humidifying section 221 and 222 is also stored in the water tank 201.

The water tank 201 is provided with a remaining water amount sensor S1 which detects the amount of the remaining water stored in the water tank 201. The remaining water amount sensor S1 measures the remaining amount of water stored in the water tank 201 and outputs an electric signal which is the measured result to the controlling section 230.

The power generating module 200 is provided with a first remaining amount sensor S21 and a second remaining amount sensor S22. When the first fuel container 100A and 100B are connected to the power generating module 200, the first remaining amount sensor S21 measures the remaining amount of the fuel 12 stored in the first fuel container 100A then outputs an electric signal which is the measured result to the controlling section 230 and the second remaining amount sensor S22 measures the remaining amount of the fuel 12 stored in the second fuel container 100B then outputs an electric signal which is the measured result to the controlling section 230.

According to the remaining amount information signal of the first remaining amount sensor S21 and the second remaining amount sensor S22, the controlling section 230 detects the fuel container between the first fuel container 100A and 100B in which the fuel 12 is less than the predetermined amount necessary for power generation (for example an empty state with no remaining amount). Then, when the amount of water in the water tank 201 is a predetermined amount which is a threshold or more and less than the acceptable amount, the controlling section 230 sends the surplus water to the fuel storing section (1A or 1B) of the fuel container (100A or 100B) in which the fuel 12 has become less than the predetermined amount necessary for power generation. Once the controlling section 230 puts water into the fuel storing section (1A or 1B) of the fuel container (100A or 100B) in which the fuel 12 has become less than the predetermined amount necessary for power generation, the controlling section 230 recognizes the remaining amount measured by the remaining amount sensor (S21 or S22) from then on is the remaining amount of water, and as described below, as long as there is collected water in the fuel storing section (1A or 1B) of the fuel container (100A or 100B) the water in the fuel storing section is supplied with higher priority than the water in the water tank 201 to the vaporizer 211, the first humidifier 221 and the second humidifier 222. When the remaining amount sensor (S21 or S22) determines that the water in the fuel container (100A or 100B) is empty, it is switched so that the water tank 201 supplies the water to the vaporizer 211, the first humidifier 221 and the second humidifier 222.

The reactor 210 comprises an vaporizer 211 which generates fuel gas (a mixture gas of evaporated fuel and water vapor) by evaporating the fuel 12 and the water supplied from the first fuel container 100A, the second fuel container 100B, and the water tank 201, a reformer 212 which generates reformed gas by reforming the fuel gas supplied from the vaporizer 211 as shown in the chemical reaction formula (1), a catalytic combustor 213 which heats the reformer 212 in order to set the reformer 212 to a temperature necessary for performing the reaction of the chemical reaction formula (1) well, and a carbon monoxide remover 214 (CO remover) which oxidizes and removes as shown in the chemical reaction formula (3) the trace amount of carbon monoxide which is generated as a by-product of the chemical reaction formula (2) which sequentially occurs after the chemical reaction (1). The reactor 210 also comprises a heater which also serves as a thermometer (not shown) so as to function as an electric heater to heat the vaporizer 211, the combustor 213, and the carbon monoxide remover 214 and to also function as a thermometer in order to measure the temperature of these reacting devices.

CH₃OH+H₂O→3H₂+CO₂ (1)

H₂+CO₂→H₂O+CO (2)

2CO+O₂→2CO₂ (3)

The first humidifier 221 humidifies the hydrogen in the reformed gas generated from the carbon monoxide remover 214 with the water supplied from the water tank 201 and supplies the hydrogen to the anode of the power generating section 220.

The second humidifier 222 humidifies the air supplied from the air pump PA with the water supplied from the water tank 201 or the water collected in the fuel storing section (1A or 1B) of the fuel container (100A or 100B) and supplies the air to the cathode of the power generating section 220. The unnecessary water discharged from the second humidifier 222 is to be collected in the water tank 201.

The power generating section 220 comprises an anode which supports a catalyst particle, a cathode which supports a catalyst particle, and a film-shaped solid high polymer electrolyte film which intervenes between the anode and the cathode. The anode of the power generating section 220 is supplied with hydrogen supplied from the carbon monoxide remover 214 and the cathode of the power generating section 220 is supplied with air from the outside by the later-described air pump PA. In the anode, the hydrogen in the mixture gas separates to a hydrogen ion and an electron under an action of the catalyst particle of the anode as shown in an electrochemical reaction formula (4). The hydrogen ion is conducted to the cathode through the solid high polymer electrolyte film, and the electron is taken out by the anode as electric energy (generated power). In the cathode, the electron which moved to the cathode, the oxygen in the air, and the hydrogen ion which passed through the solid high polymer electrolyte film reacts and generates water. The offgas which includes the hydrogen unreacted in the anode is sent to the combustor 213, and the water generated in the cathode and the air unreacted in the cathode is sent to the water tank 201 as discharge.

H₂→2H⁺+2e⁻ (4)

2H⁺+½O₂+2e⁻→H₂O (5)

Besides the first and second fuel containers 100A and 100B, the water tank 201, the reactor 210, the power generating section 220, etc., the power generating system 300 comprises a first fuel pump P31 which supplies the fuel 12 in the first fuel container 100A to the vaporizer 211 and a second fuel pump P32 which supplies the fuel 12 in the second fuel container 100B to the vaporizer 211. The power generating system 300 comprises a first water pump P1 which supplies the water in the water tank 201 to the vaporizer 211, a second water pump P2 which supplies the water selected between the collected water in the fuel storing section (1A or 1B) of the fuel container (100A or 100B) and the water in the water tank 201 to the first and second humidifier 221 and 222, a third water pump P3 which sends the water collected in the water tank 201 to the first or second fuel container 100A or 100B, a fourth water pump P4 which supplies and reuses the water collected in the fuel storing section 1A of the first fuel container 100A to the vaporizer 211 through a flow path switching section R1, and a fifth water pump P5 which supplies and reuses the water collected in the fuel storing section 1B of the second fuel container 100B to the vaporizer 211 through a flow path switching section R2. The power generating system 300 comprises an air pump PA to introduce air into the power generating system 300 from the outside.

A first valve V1 is connected to the first fuel pump P31 and the second fuel pump P32 and a first flow meter F1 is connected to the first valve V1. The first valve V1 is provided between the vaporizer 211 and the first and second fuel pumps P31 and P32, and the open/close action blocks or allows the flow of the fuel 12 from the first fuel pump P31 to the vaporizer 211 and blocks or allows the flow of the fuel 12 from the second fuel pump P32 to the vaporizer 211. The first flow meter F1 is provided between the first valve V1 and the vaporizer 211 and measures the flow rate of the fuel 12 which passes the first valve V1. The controlling section 230 allows only either one of the first fuel pump P31 or the second fuel pump P32 to operate and controls the first valve V1 so as to maintain the flow rate of the first flow meter F1 to a certain level.

The fuel discharge opening 11 of the first fuel container 100A is connected to the flow path switching section R1. When according to the detection of the remaining amount by the first remaining amount sensor S21 the fuel 12 in the fuel storing section 1A is determined to be remaining, the flow path switching section R1 switches the flow path to the first fuel pump P31. When the water is collected in the fuel storing section 1A after the fuel 12 in the fuel storing section 1A is determined to be less than the predetermined amount necessary for power generation, the flow path switching section R1 switches the flow path to the fourth water pump P4.

Similarly, the fuel discharge opening 11 of the second fuel container 100B is connected to the flow path switching section R2. When according to the detection of the remaining amount by the second remaining amount sensor S22 the fuel 12 in the fuel storing section 1B is determined to be remaining, the flow path switching section R2 switches the flow path to the second fuel pump P32. When the water is collected in the fuel storing section 1B after the fuel 12 in the fuel storing section 1B is determined to be less than a predetermined amount necessary for power generation, the flow path switching section R2 switches the flow path to the fifth water pump P5.

A second valve V2 is connected to the first water pump P1 and a second flow meter F2 is connected to the second valve V2. The second valve V2 is provided between the first water pump P1 and the vaporizer 211 and the open/close action blocks or allows the flow of the water from the first water pump P1 to the vaporizer 211. The second flow meter F2 is provided between the second valve V2 and the vaporizer 211 and measures the flow rate of the water which passes the second valve V2. The fuel 12 discharged from the first valve V1 and the water discharged from the second valve V2 is mixed before reaching the reactor 210. When there is no collected water in the fuel storing section (1A or 1B) of the fuel container (100A or 100B) in which the fuel 12 is less than the predetermined amount necessary for power generation, the controlling section 230 controls the first water pump P1 and the second valve V2 so as to supply the water in the water tank 201 to the vaporizer 211. The discharge from the combustor 213 (water, gas including water vapor, offgas, etc.) is sent to the water tank 201.

The second water pump P2 is connected to the later-described flow path switching section R3 and flow path switching section R4, and is also connected to the first humidifier 221 and the second humidifier 222, and the water from the flow path switching section R3 or the flow path switching section R4 is supplied to the first humidifier 221 and the second humidifier 222.

The third water pump P3, a third valve V3, and a flow path switching section R5 are connected between the water tank 201 and the fuel storing section 1A of the first fuel container 100A and between the water tank 201 and the fuel storing section 1B of the second fuel container 100B. The first remaining amount sensor S21 and the second remaining amount sensor S22 perform measurements of the remaining amounts of the fuel 12 and when there is a fuel container (100A or 100B) in which the fuel 12 is less than the predetermined amount necessary for power generation, the flow path switching section R5 switches the flow path exclusively so that the fuel container (100A or 100B) with less than the predetermined amount is in communication with the third valve V3 and the fuel container (100B or 100A) in which the fuel 12 is not less than the predetermined amount necessary for power generation is not in communication with the third valve V3. When the remaining amount of water in the water tank 201 detected by the remaining water amount sensor S1 is a predetermined amount or more and less than the acceptable amount, the third water pump P3 and the third valve V3 operates and sends water from the water tank 201 to the fuel storing section (1A or 1B) of the fuel container (100A or 100B) in which the fuel 12 is less than the predetermined amount necessary for power generation. It is preferable that the amount of water left in the water tank 201 after the water is sent is a sum of the amount of water necessary for the vaporizer 211 at starting up and the amount of water necessary for the first humidifier 221 and the second humidifier 222 to humidify at starting up. Thus, the water is not collected beyond the acceptable amount in the water tank 201.

The flow path switching section R1 is connected to the flow path in communication with the first fuel pump P31 and the flow path in communication with the fourth water pump P4 and the flow path switching section R3. In a state in which the fuel 12 is discharged from the fuel storing section 1A of the fuel container 100A, the flow path switching section R1 is set so that the flow path of the fuel 12 discharged from the fuel discharge opening 11 is in communication with the first fuel pump P31. When the vaporizer 211 and the power generating section 220 continue to operate after the fuel 12 discharged from the fuel storing section 1A of the fuel container 100A is less than the predetermined amount necessary for power generation and the water is collected in the fuel container 100A with less than the predetermined amount necessary for power generation, the controlling section 230 switches the flow path switching section R1 so that the flow path of the water discharged from the fuel discharge opening 11 is connected to the flow path connected to the fourth water pump P4 and the flow path switching section R3.

The flow path switching section R2 is connected to the flow path in communication with the second fuel pump P32 and the flow path in communication with the fifth water pump P5 and the flow path switching section R4. In a state in which the fuel 12 is discharged from the fuel storing section 1B of the fuel container 100B, the flow path switching section R2 is set so that the flow path of the fuel 12 discharged from the fuel discharge opening 11 is in communication with the second fuel pump P32. When the vaporizer 211 and the power generating section 220 continues to operate after the fuel 12 discharged from the fuel storing section 1B of the fuel container 100B is less than the predetermined amount necessary for power generation and the water is collected in the fuel container 100B with less than the predetermined amount necessary for power generation, the controlling section 230 switches the flow path switching section R2 so that the flow path of the water discharged from the fuel discharge opening 11 is connected to the fifth water pump P5.

A sixth valve V6 is connected to the fourth water pump P4 and the fifth water pump P5 and a third flow meter F3 is connected to the sixth valve V6. The sixth valve V6 is provided between the vaporizer 211 and the fourth and fifth water pump P4 and P5 and the open/close action blocks or allows the flow of the water from the fourth or fifth water pump P4 and P5 to the vaporizer 211. The third flow meter F3 is provided between the sixth valve V6 and the vaporizer 211 and measures the flow rate of the water which passes the sixth valve V6. The fuel 12 discharged from the first valve V1 and the water discharged from the sixth valve V6 is mixed before reaching the reactor 210.

The flow path switching section R3 is further connected to the water tank 201 and the second water pump P2. In a state in which it is determined that the fuel 12 exists in the fuel storing section 1A and the power generating section 220 is generating power or just before starting the power generation, the flow path switching section R3 connects the water tank 201 so as to be in communication with the second water pump P2 to supply the water in the water tank 201 to the first humidifier 221 and the second humidifier 222. In a state in which it is determined that the water exists in the fuel storing section 1A and the power generating section 220 is generating power or just before starting the power generation, the flow path switching section R3 switches the flow path so that the water collected in the fuel storing section 1A is sent to the second water pump P2 to supply the water to the first and second humidifiers 221 and 222.

The flow path switching section R4 is further connected to the water tank 201 and the second water pump P2. In a state in which it is determined that the fuel 12 exists in the fuel storing section 1B and the power generating section 220 is generating power or just before starting the power generation, the flow path switching section R4 connects the water tank 201 so as to be in communication with the second water pump P2 to supply the water in the water tank 201 to the first humidifier 221 and the second humidifier 222. In a state in which it is determined that the water exists in the fuel storing section 1B and the power generating section 220 is generating power or just before starting the power generation, the flow path switching section R3 switches the flow path so that the water collected in the fuel storing section 1A is sent to the second water pump P2 to supply the water to the first and second humidifiers 221 and 222.

A fourth valve V4, a fifth valve V5, and the second humidifier 222 are connected to the air pump PA. The fourth valve V4 is provided between the air pump PA and the carbon monoxide remover 214 and the open/close action blocks or adjusts the flow of the air from the air pump PA to the carbon monoxide remover 214.

The fifth valve V5 is provided between the air pump PA and the combustor 213 and the open/close action blocks or adjusts the flow of the air from the air pump PA to the combustor 213.

The first to fifth water pumps P1 to P5, the first fuel pump P31, the second fuel pump P32 and the air pump PA are electrically connected to the controlling section 230 through drivers D1 to D5, D31, D32, and D4. The controlling section 230 comprises, for example a general-purpose CPU (Central Processing Unit), RAM (Random Access Memory) and ROM (Read Only Memory). The controlling section 230 sends control signals to the first to fifth water pumps P1 to P5, the first fuel pump P31, the second fuel pump P32 and the air pump PA and controls the pumping action (including the adjustment of the sending amount) of the first to fifth water pumps P1 to P5, the first fuel pump P31, the second fuel pump P32 and the air pump PA.

The flow path switching sections R1 to R4 are electrically connected to the controlling section 230. The first to sixth valves V1 to V6 are electrically connected to the controlling section 230 through drivers D11 to D16. The first to third flow meters F1 to F3 are electrically connected to the controlling section 230. The controlling section 230 can recognize the flow rate of the fuel 12 and the water by receiving the results measured by the first to third flow meters F1 to F3. The controlling section 230 can also control the open/close action (including the adjustment of the opening size) of the first to sixth valve V1 to V6 and the switching operation of the flow path switching section R5 so that between the fuel storing section 1A of the first fuel container 100A and the fuel storing section 1B of the second fuel container 100B the fuel storing section in which the fuel 12 is less than the predetermined amount necessary for power generation is selected and the discharge (water) which is discharged from the power generating module 200 is collected in the selected fuel storing section.

The vaporizer 211, the reformer 212, the combustor 213 and the electric heater which heats the carbon monoxide remover 214 are electrically connected to the controlling section 230 through a driver D21. The controlling section 230 controls the heating value and stopping the operation of the electric heater and is able to detect the temperature of the reactors, which are the vaporizer 211, the reformer 212, the combustor 213 and the carbon monoxide remover 214, by measuring the resistance value of the electric heater which changes according to the temperature. When the reactor 210 is started, the electric heater heats the vaporizer 211, the reformer 212, the combustor 213, and the carbon monoxide remover 214 to an appropriate temperature and after the combustor 213 starts combustion and can stably apply heat, the operation of the electric heater may be stopped or the heating amount by the electric heater may be reduced.

The first and second remaining amount sensor S21 and S22 and the remaining water amount sensor S1 are electrically connected to the controlling section 230. The controlling section 230 determines whether the first and second fuel containers 100A and 100B are attached and detects the remaining amount of the fuel 12 which is measured by the first remaining amount sensor S21 and the remaining amount of the fuel 12 which is measured by the second remaining amount sensor S22. Then the controlling section 230 controls the power generating system 300 so that when each remaining amount is less than the predetermined amount necessary for power generation, the power generating system 300 is not started or the operation stops, and when the remaining amount is not less than the predetermined amount necessary for power generation, the power generating system 300 is started or the operation is maintained.

When the power generating system 300 is started, according to the remaining amount result of the fuel 12 by the first and second remaining amount sensors S21 and S22, if the fuel 12 remains in both fuel containers 100A and 100B, the controlling section 230 supplies the fuel 12 from either one of the fuel containers, and if one of the fuel containers is less than the predetermined amount necessary for power generation, the controlling section 230 supplies the fuel 12 from the other fuel container (100A or 100B) with the predetermined amount of the fuel 12 necessary for power generation remaining.

A DC/DC converter 240 is connected to the power generating section 220 and an external power source, that is an external device (load) which can operate by receiving power supply from the power generating system 300 is connected to the DC/DC converter 240. The DC/DC converter 240 is a device which converts a voltage output from the power generating section 220 to a predetermined voltage according to the standard of the external electronic device so as to output to an external electronic device. The DC/DC converter 240 is connected to the controlling section 230 and the controlling section 230 can detect the input power input from the power generating section 220 to the DC/DC converter 240.

A secondary cell 241 is connected to the DC/DC converter 240. For example, the secondary cell 241 stores surplus electric energy obtained from the power generating section 220 and when the power generating section 220 stops generating electric energy, the secondary cell 241 can supply the power to the external electronic device as a substitute for power generating section 220. At starting up, the controlling section 230, the drivers, the sensors and the electric heater of the reactor 210 are electrically driven by a portion of the output from the secondary cell 241 through the DC/DC converter 240, and are electrically driven by a portion of the output from the power generating section 220 through the DC/DC converter 240 when the output of the power generating section 220 becomes a stable state.

The power generating system 300 comprising the above structure is attached in an electronic device (external electronic device) such as a desktop personal computer, a laptop personal computer, a cellular phone, a PDA (Personal Digital Assistant), an electronic organizer, a watch, a digital still camera, a digital video camera, a game machine, or a household appliance, as a power source in order to operate the external electronic device.

Next, the operation of the power generating system 300 is described.

The power generating system 300 is activated by input of an activating signal to the controlling section 230 through the communication terminal and communication electrode from the external electronic device. Thus, the controlling section 230 activates the first water pump P1, the second water pump P2, and the air pump PA, and also allows the electric heater to generate heat through the driver D21. While the power generating system 300 is in operation, according to the data of the temperature fed back from the electric heaters, the controlling section 230 controls the temperature of the electric heaters so as to maintain it at a predetermined temperature. Even if one of the fuel containers (100A or 100B) in which the fuel has become less than the predetermined amount of fuel necessary for power generation is filled with water, the water tank 201 stores water of the amount necessary for the vaporizer 211 at starting up, and the amount necessary for the first and second humidifiers 221 and 222 to humidify at starting up. The above-described necessary amount of water is the least amount of water which enables continuous supply of water to the vaporizer 211, the first humidifier 221 and the second humidifier 222 until water generated in the power generating section 220, etc., is supplied to the water tank 201 after starting.

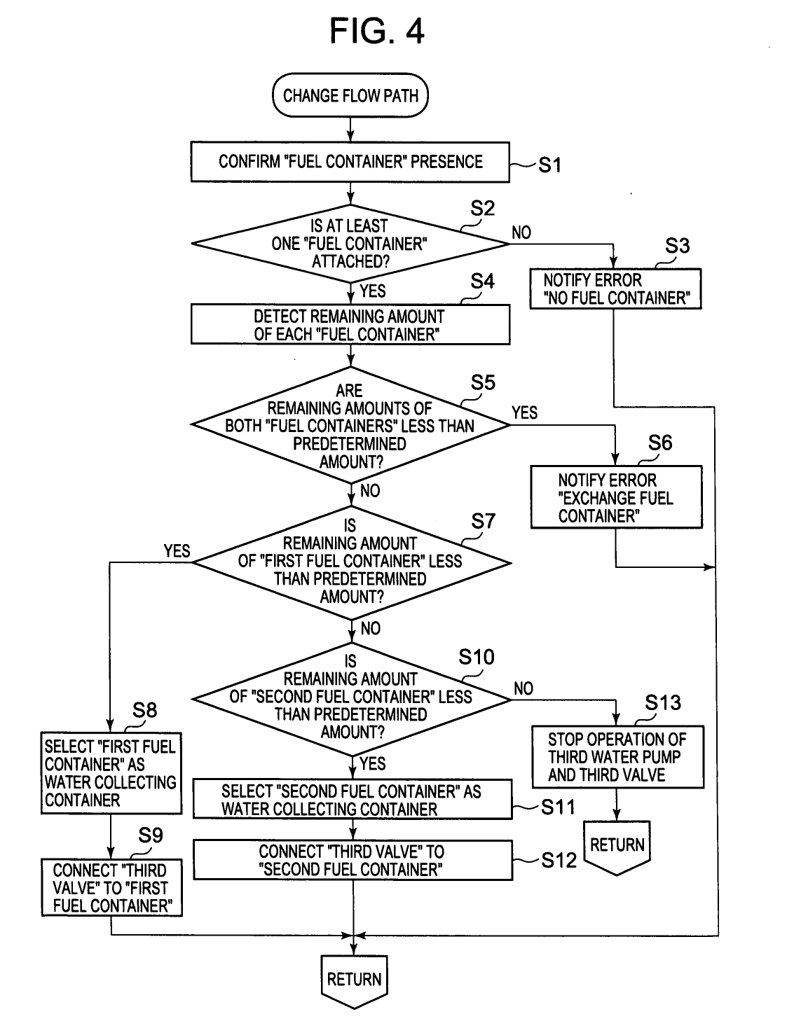

The controlling section 230 controls the switching operation of the third valve V3 as described below. FIG. 4 is a flow chart showing switching operation processing of a flow path switching section.

First, the controlling section 230 confirms whether the first fuel container 100A and the second fuel container 100B are attached to the power generating module 200 respectively (step S1). It is determined whether at least either one of the fuel containers (100A or 100B) is attached (step S2), and when neither of the fuel containers (100A or 100B) is attached, an error notification of “no fuel container” is given (step S3). When at least one of the fuel containers (100A or 100B) is attached, the first remaining amount sensor S21 and the second remaining amount sensor S22 detect the remaining amounts of the fuel 12 (step S4). At this time, the remaining amount of fuel 12 of the fuel container 100A or the fuel container 100B which is not attached is considered to be less than the amount (predetermined amount) of fuel enough to perform power generation by the power generating section 220. However, the water generated in the power generating section 220, etc., is not sent to the side where the fuel container is not attached.

Then, it is determined whether the remaining amounts of the fuel 12 in both of the first and second fuel containers 100A and 100B is less than the predetermined amount enough to perform power generation (step S5). When the remaining amounts of the fuel 12 in both of the first and second fuel containers 100A and 100B are less than the predetermined amount, an error notification of “exchange fuel container” is given (step S6). When both of the first and second fuel containers 100A and 100B are attached and the remaining amount of the fuel 12 of at least one of the fuel containers (100A or 100B) is not less than the predetermined amount, it is determined whether the remaining amount of the fuel 12 in the first fuel container 100A is less than the predetermined amount necessary for power generation (step S7). When the remaining amount of the fuel 12 in the fuel container 100A is less than the predetermined amount necessary for power generation, the first fuel container 100A is selected as the water collecting container (step S8), and the flow path switching section R5 switches the flow path exclusively so that the fuel container 100A is in communication with the third valve V3 and the fuel container 100B does not communicate with the third valve V3 (step S9).

In step S7, when the remaining amount of the fuel 12 in the first fuel container 100A is not less than the predetermined amount necessary for power generation, it is determined whether the remaining amount of the fuel 12 in the second fuel container 100B is less than the predetermined amount necessary for power generation (step S10). When the remaining amount of the fuel 12 in the second fuel container 100B is less than the predetermined amount necessary for power generation, the second fuel container 100B is selected as the water collecting container (step S11), and the flow path switching section R5 switches the flow path exclusively and connects the third valve V3 to the second fuel container 100B so that the fuel container 100B is in communication with the third valve V3 and the fuel container 100A is not in communication with the third valve V3 (step S12).

In step S10, when the remaining amount of the fuel 12 in the second fuel container 100B is not less than the predetermined amount necessary for power generation, the third water pump P3 is not operated and the third valve V3 is closed (step S13).

As described above, the controlling section 230 executes the flow shown in FIG. 4 repeatedly at intervals, that is, monitors whether the first and second fuel containers 100A and 100B are attached, and switches the communication of the third valve V3 according to the remaining amounts of the fuel 12 in the fuel containers 100A and 100B. The controlling section 230 switches the third valve V3 so that the fuel container (100A or 100B) in which the fuel 12 is less than the predetermined amount necessary for power generation is applied as a water collecting container.

When both of the fuel containers 100A and 100B run out of the fuel 12, the error notification of replacing the fuel containers is given and the operation of the power generating system 300 stops. When the fuel container is exchanged with a new fuel container, the power generating system 300 activates, then the above flow is executed. Thus, continuous operation is enabled.

Next, the operation after the switching operation by the flow path switching section R5 of the fuel container (100A or 100B) to collect water is described.

In the description below, for the convenience of explanation, an example in which both the first fuel container 100A and the second fuel container 100B are attached to the power generating system 200 and for example the fuel 12 of the first fuel container 100A is used, then the remaining amount of the fuel 12 in the first fuel container 100A becomes less than the predetermined amount necessary for power generation and the fuel 12 is left in the second fuel container 100B.

First, when the first fuel pump P31 is activated, the fuel 12 in the fuel storing section 1A of the first fuel container 100A is sent from the fuel discharge tube 11A through the first valve V1 and the first flow meter F1. The fuel 12 is mixed with the water supplied by the operation of the first-water pump P1 and the second valve V2 from the water tank 201 and sent to the vaporizer 211 of the reactor 210. When the second water pump P2 is activated, the water in the water tank 201 is sent to the first and second humidifiers 221 and 222 provided in the cathode of the power generating section 220. When the air pump PA is activated, the outside air is sent to the combustor 213 through the fifth valve V5, and to the carbon monoxide remover 214 through the fourth valve V4. When the air pump PA is activated, the outside air is sent to the second humidifier 222. Here, according to the flow data fed back from the flow meters F1 and F2, the controlling section 230 controls the valves V1 to V3 so that the flow rate is a predetermined flow rate.

In the vaporizer 211, the fuel 12 supplied from the fuel container 100A and the water supplied from the water tank 201 are mixed and heated to be evaporated (vaporized), and the fuel 12 (methanol) and the water (water vapor) form a mixture gas to be supplied to the reformer 212.

In the reformer 212, the methanol and the water vapor in the mixture gas supplied by the vaporizer 211 react to the catalyst to generate carbon dioxide and hydrogen (see above-mentioned chemical reaction formula (1)). In the reformer 212, subsequent to the chemical reaction formula (1) carbon monoxide is sequentially generated (see above-mentioned chemical reaction formula (2)). The mixture gas generated in the reformer 212 including carbon monoxide, carbon dioxide, hydrogen, etc. is supplied to the carbon monoxide remover 214.

In the carbon monoxide remover 214, carbon dioxide and hydrogen is generated from the carbon monoxide and the water vapor in the mixture gas supplied from the reformer 212 and the carbon monoxide uniquely chosen from the mixture gas and the oxygen included in the air supplied from the fourth valve V4 react and generate carbon dioxide (see above-mentioned chemical reaction formula (3)).

As shown above, carbon dioxide and hydrogen is generated from the fuel 12, after passing through the vaporizer 211, the reformer 212, and the carbon monoxide remover 214 of the reactor 210. The reformed gas (carbon dioxide, hydrogen, etc.) generated in the reactor 210 is supplied to the first humidifier 221. The first humidifier 221 is supplied with water supplied from the water tank 201 through the flow path switching section R3, the second water pump P2 and the second humidifier 222, and after humidifying the reformed gas, supplies the reformed gas to the anode of the power generating section 220.

As for the reformed gas supplied to the anode of the power generating section 220, the hydrogen in the reformed gas separates to hydrogen ion and electron as shown in the above-mentioned chemical reaction formula (4).

Air is supplied to the second humidifier 222 through the air pump PA. After the second humidifier 222 is supplied with water which is supplied from the water tank 201 through the flow path switching section R3 and the second water pump P2, and the air is humidified by allowing the air to pass through the supplied water, then the air is supplied to the cathode of the power generating section 220.

As for the air supplied to the cathode of the power generating section 220, the oxygen in the air reacts to the hydrogen ion and electron as shown in the above-mentioned chemical reaction formula (5), and water is generated as a by-product.

The unreacted hydrogen in the anode is sent to the combustor 213 as offgas and combusted, to be used as energy in order to heat reactor 210 when necessary. The water included in the discharged gas obtained by combustion in the combustor 213 is stored in the water tank 201 and the other gases such as carbon dioxide are discharged outside the power generating system 300.

In the cathode, the supplied air is discharged with the water, which is the by-product and stored in the water tank 201.

Here, when it is detected that the amount of the fuel 12 in the first fuel container 100A is less than the predetermined amount necessary for power generation, and the amount of water in the water tank 201 is a predetermined amount, which is a threshold, or more, the flow path is switched by the flow path switching section R5 so that the third valve V3 is in communication with the fuel container 100A with less than the predetermined amount, and the third water pump P3 and the third valve V3 is activated. At this time, the sum (for example 10 ml) of the amount of water necessary for the vaporizer 211 at starting up and the amount of water necessary for the first humidifier 221 and the second humidifier 222 to humidify at starting up is left in the water tank 201 and the surplus water is sent to the fuel container 100A by the third water pump P3. Therefore, the surplus water is not sent to the second fuel container 100B in which the fuel 12 is still left, thus an indefinite amount of water and fuel 12 are not mixed so the fuel 12 can be used in the power generating module 200. The water tank 201 may be set so that the water is sent in order to exceed the necessary amount at starting up and to maintain the predetermined amount, which is the threshold.

The electric energy generated by the power generating section 220 is charged in the secondary cell 241. The generated electric energy is supplied to the DC/DC converter 240 and the electric energy is converted to a predetermined voltage of a direct current and is supplied to the external electronic device. The external electronic device operates with the supplied electric energy.

In the above description, an example in which the fuel 12 of the first fuel container 100A is used, however the fuel 12 in the second fuel container 100B may be used, or both fuel containers 100A and 100B may be used. In this case, the fuel container (100A or 100B) in which the amount of the fuel 12 is less than the predetermined amount may be used to collect water and the other operations is the same as the above, thus the explanation will be omitted.

Next, a case in which the water is reused when the water is collected in the fuel storing section (1A or 1B) of the fuel container (100A or 100B) in which the amount of the fuel 12 is less than the predetermined amount necessary for power generation will be described with reference to FIG. 3.

An example in which the water collected in the first fuel container 100A is reused will be explained.

First, when the water is collected in the fuel storing section 1A of the first fuel container 100A, it is determined according to the remaining amount information from the first remaining amount sensor S21 that the remaining amount of fuel 12 is less than the predetermined amount necessary for power generation and that there is still remaining water left, and the flow path switching section R1 switches the flow path from the first fuel pump P31 to the fuel path switching section R3 and the fourth water pump P4.

At this time, the fuel 12 is stored in the fuel storing section 1B of the second fuel container 100B, thus according to the remaining amount information from the second remaining amount sensor S22, the flow path switching section R2 remains connected to the second fuel pump P32, and the flow path is not switched to the flow path switching section R4 and the fifth water pump P5.

The fuel 12 in the fuel storing section 1B of the second fuel container 100B is sent to the vaporizer 211 of the reactor 210 through the fuel discharge tube 11B, the first valve V1 and the first flow meter F1. The flow path switching section R1 switches the flow path to the flow path switching section R3 and the fourth water pump P4 in order to activate the fourth water pump P4, and the collected water in the fuel storing section 1A of the first fuel container 100A is sent to the vaporizer 211 of the reactor 210 through the fuel discharge tube 11A, the sixth valve V6, and the third flow meter F3. By determining that there is water remaining in the first fuel container 100A according to the remaining amount information of the first remaining amount sensor S21, the flow path switching section R3 switches the flow path from the water tank 201 to the fuel storing section 1A and the water collected in the fuel storing section 1A is preferentially used. With this, the second water pump P2 is activated and the water collected in the fuel storing section 1A is sent to the first and second humidifiers 221 and 222 provided in the cathode of the power generating section 220. Then, the air pump PA is activated and the outside air is sent to the combustor 213 through the fifth valve V5 and to the carbon monoxide remover 214 through the fourth valve V4. According to the flow rate data fed back from the flow meters F1 and F3, the controlling section 230 controls the valves V1, V7, V3 and V4 so as to maintain a predetermined flow rate.

Then, as described above, the fuel 12 and the water are passed through the vaporizer 211, the reformer 212 and the carbon monoxide remover 214 of the reactor 210 and reformed. By supplying reformed gas to the anode of the power generating section 220, and the air to the cathode of the power generating section 220, electric power is generated and the unreacted hydrogen generated in the anode is sent to the combustor 213 which is used for combustion so that the discharged gas obtained from the combustor 213 is stored in the water tank 201. In the cathode, the supplied air is discharged with the water, which is the by-product, and stored in the water tank 201.

Then, the surplus water according to the remaining water amount information from the remaining water amount sensor S1 is sent to the fuel container (100A or 100B) in which the amount of the fuel 12 is less than the predetermined amount necessary for power generation, and the above-described operation is repeated.

As described above, according to the power generating system 300, the discharge path is changed by the third valve V3 so that the discharge is collected in the fuel storing section (1A or 1B) of the fuel container (100A or 100B) in which the amount of the fuel 12 is less than the predetermined amount necessary for power generation. Thus the discharge is not collected in the fuel container (100A or 100B) in which the fuel 12 remains, so the mixing of the fuel 12 and the discharge can be prevented. The fuel container (100A or 100B) which is not supplying the fuel 12 is not pressurized. Thus, the fuel 12 does not leak out of the fuel container (100A or 100B) which is not supplying the fuel 12.

Before the discharge is collected in the fuel container (100A or 100B) in which the amount is less than the predetermined amount, after the water is collected in the water tank 201 and before the water exceeds the acceptable amount of the water tank 201, the surplus water can be collected in the fuel container (100A or 100B) in which the amount is less than the predetermined amount, thus the water in the water tank 201 does not exceed the acceptable amount and is not damaged. The discharge is collected in the water tank 201 so the discharge may be reused, which is economical. The fuel container in which the surplus water is collected may be removed and disposed.

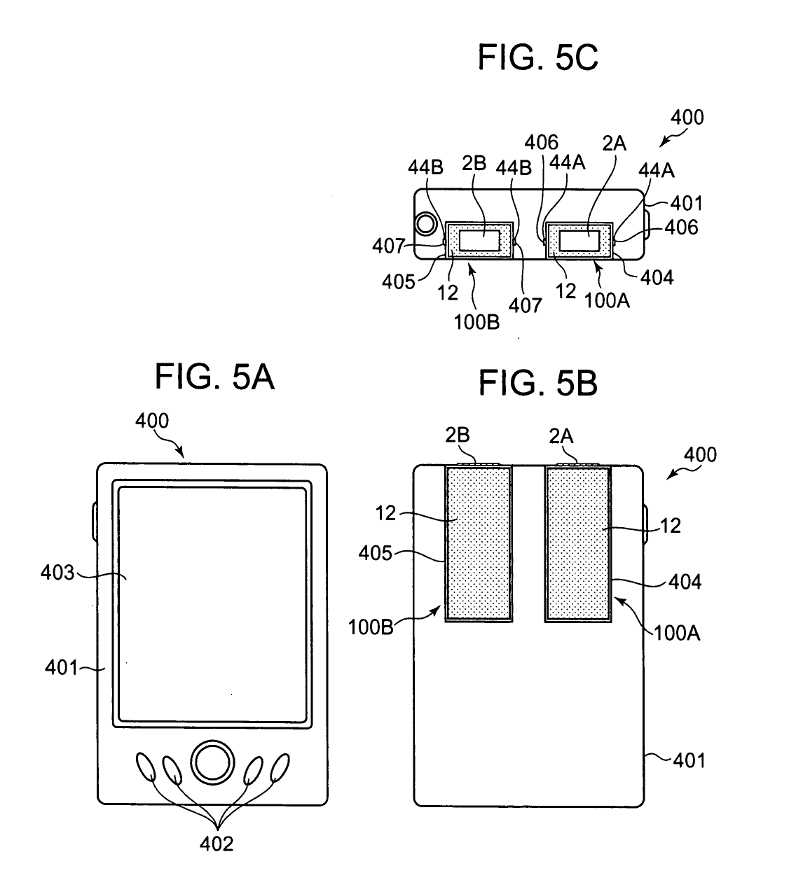

A case in which the power generating system 300 is applied to the electronic device 400 is described. Specifically, the electronic device is a portable electronic device, and the system is applied to a PDA. FIG. 5A is a top view of an electronic device 400, FIG. 5B is a bottom view of the electronic device 400 of FIG. 5A, and FIG. 5C is a rear view of the electronic device 400 of FIG. 5A.

The electronic device 400 comprises a main body 401 embedded with a processing circuit including a CPU, a RAM, a ROM and other electronic parts, a first fuel container 100A and a second fuel container 100B to store fuel 12 which is removably attached to the main body 401, and a power generating module (not shown) which is provided in the main body 401 and which uses the fuel 12 in the first and second fuel containers 100A and 100B in order to generate power, and the generated electric energy is supplied to the main body 401 in order to drive the main body 401. The structure and the operation of the first and second fuel containers 100A and 100B and the power generating module (not shown) are the same as those described above, thus the description is omitted.

The main body 401 comprises operation keys 402 and a liquid crystal display 403, and a first storing space 404 and a second storing space 405 are formed in a rectangular shape which stretch in a horizontal direction on the bottom side of the main body 401 so as to be symmetric with respect to a central line in a horizontal direction and are open toward the bottom side and the rear side. The first fuel container 100A and the second fuel container 100B may be stored in the first and second storing spaces 404 and 405 from the rear side opening of the main body 401. Rails 406, 406, 407, and 407 are formed on the walls in the longitudinal direction which form the first and second storing spaces 404 and 405 and the rails, engage to the guides 44A, 44A, 44B, and 44B formed on the fuel containers 100A and 100B. The first fuel container 100A and the second fuel container 100B are attached to the storing spaces 404 and 405 by sliding the fuel containers 100A and 100B from the end section of the discharge opening and supply opening so that the gas-liquid separation film 2A and 2B face outward, and engaging the guide section 44A, 44A, 44B, and 44B to the rail section 406, 406, 407, and 407, respectively.

As described above, the fuel containers 100A and 100B stored in the storing spaces 404 and 405 respectively are attached so that the bottom side is exposed to the outside, thus the bottom side is in direct contact with the outside air so the heat is dissipated well, and the heat is not trapped in the power generating system 300, which raises the water collection rate.

As for the present invention, the number of times the cartridge is changed is less than in a structure in which the fuel cartridge and the cartridge for collecting water is different as mentioned in the Japanese Patent Application Laid-open No. 2004-192171, etc. For example, when the fuel cartridge is empty and the cartridge for collecting water is full, in a structure mentioned in Japanese Patent Application Laid-open No. 2004-192171, etc., both cartridges need to be changed, however in the present invention, in a similar situation, only the cartridge for collecting water needs to be changed to a new fuel cartridge.

In the above embodiment, the power generating module 200 stores two fuel containers and when one fuel container is out of fuel, the by-product is collected in the fuel container, but the structure is not limited to this, and the power generating module 200 may store only one fuel container and after the fuel container runs out of fuel, the by-product may be collected in the fuel container. By alternately changing the fuel containers 100A and 100B which has run out of fuel, not only can the electronic device operate continuously, but also the by-product can be easily collected.

### [Modification]

Next, a modification of the fuel container will be described.

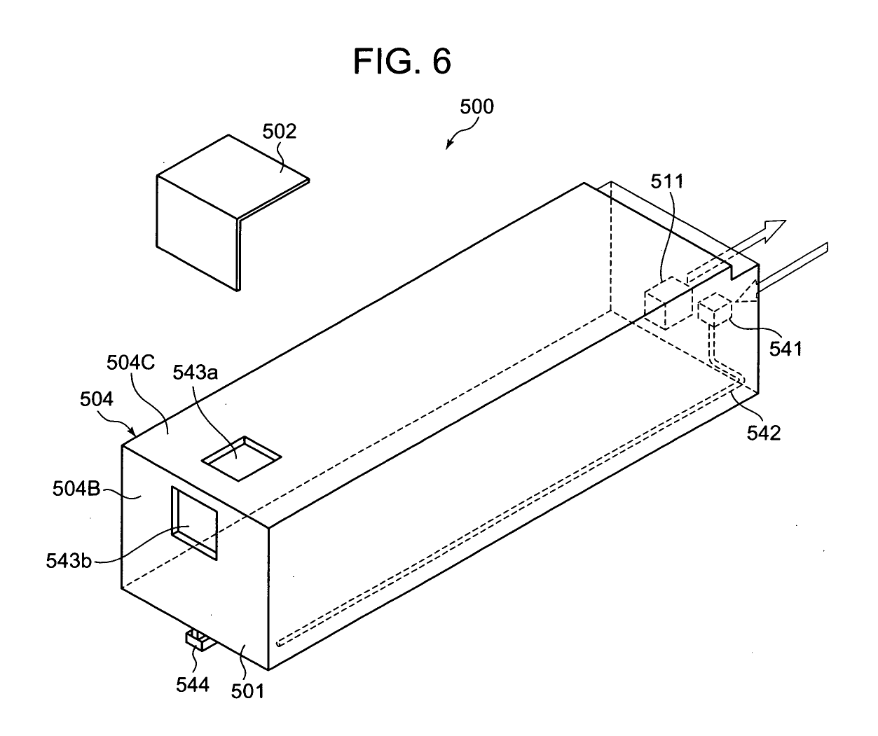

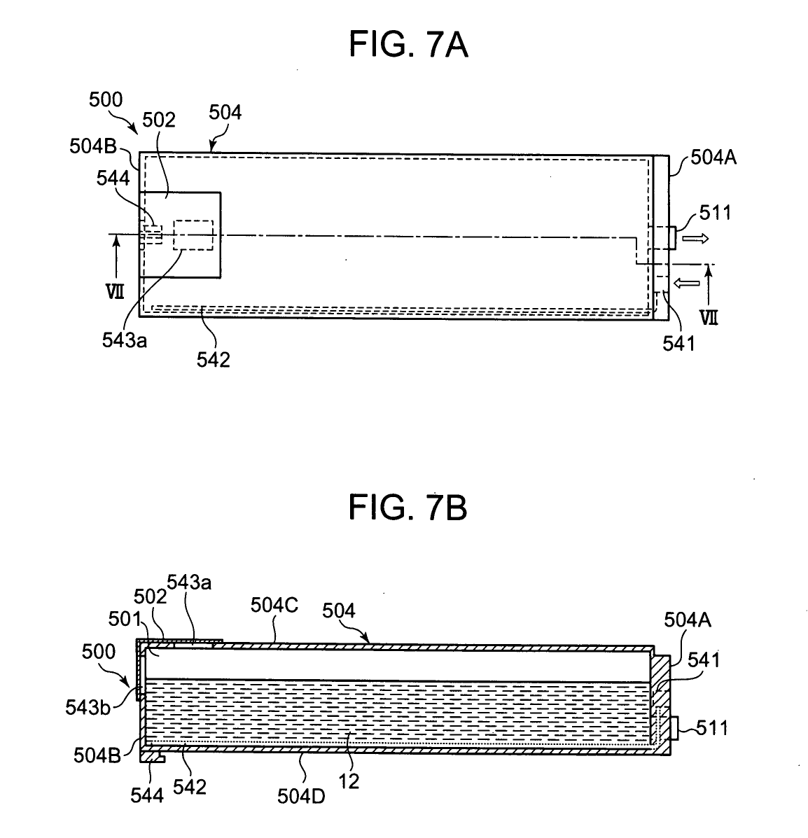

FIG. 6 is an exploded perspective view of a fuel container 500, FIG. 7A is a top view of the fuel container 500, and FIG. 7B is a sectional view taken along cross-section line VII-VII.

The fuel container 500 is different from the fuel container 100 of the first embodiment. Openings 543a and 543b formed on the case 504, a gas-liquid separation film 502 which is attached to the openings 543a and 543b and includes a hydrophobic porous membrane, and a guide section 544 are different. The fuel storing section 501 is the same as the above described fuel storing section 1, the fuel discharge opening 511 is the same as the fuel discharge opening 11, the discharge collecting opening 541 is the same as the discharge collecting opening 41, the discharge sending tube 542 is the same as the discharge sending tube 42, thus detailed descriptions are omitted.

The fuel container 500 includes a fuel storing section 501 to store fuel 12. The fuel storing section 501 cools and collects discharge including gas and water discharged from a power generating module (not shown) which generates power with the fuel 12 supplied from the fuel storing section 501.

On a right end surface 504A of the case 504, a fuel discharge opening 511, which discharges the fuel 12 to the power generating module is formed in a convex shape projecting outward from the right end surface 504A by penetrating the end surface 540A so as to be in communication with the inside of the fuel storing section 501. On the right end surface 504A of the case 504, at the upper side of the fuel discharge opening 511, a discharge collecting opening 541 is formed. A fuel discharge opening (not shown) is provided in the fuel discharge opening 511 and a discharge supplying opening (not shown) is provided in the discharge collecting opening 541. As described above, a check valve (not shown) is fitted in the fuel discharge opening and the discharge supplying opening. A discharge sending tube 542 is connected to the discharge collecting opening 541, and is laid on the lower side from the discharge collecting opening 541 and extends toward the left end surface of the fuel storage section 501 along the longitudinal direction.

On the upper surface 504C in the side of the opposite end surface 504B in the longitudinal direction of the case 504 (left end surface in FIG. 6), a rectangular opening 543a which communicates to the inside of the case 504 is formed, and on the left end surface 504B a rectangular opening 543B which communicates to the inside of case 4 is formed. A gas-liquid separation film 502 is folded so as to straddle the two openings 543a and 543b and to cover these openings 543a and 543b. Thus, gas may pass between inside and outside of the case 504 through the gas-liquid separation film 502 but water may not pass through the gas-liquid separation film 502. Therefore, the water does not leak outside. The gas-liquid separation film 502 is attached so as to straddle the two openings 543a and 543b, thus air may be discharged from two places, the openings 543a and 543b.

A guide 544 is attached to a bottom surface 504D at the left end side of the case 504 for removably attaching the case 504 to a later-described electronic device 800. The guide 544 projects downward from the bottom surface 504D of the case 504 and is T-shaped from a side sectional view (See FIG. 6).

The fuel 12 inside the fuel storing section 501 in the above-described fuel container 500 is supplied to the power generating module through the fuel discharge opening 511 and the fuel 12 is used to generate electric energy. The discharge produced from the power generating module is supplied into the discharge sending tube 542 through the discharge collecting opening 541, then flows through the discharge sending tube 542 to be sent to the fuel storing section 501. The gas in the discharge is cooled while flowing in the discharge sending tube 542, and a portion is condensed to water to be collected in the fuel storing section 501. The gas which was not condensed is released outside through the gas-liquid separation film 502 and the water cannot pass through the gas-liquid separation film 502 and is accumulated in the fuel storing section 501. The cooling of the discharge is also promoted by the water collected in the fuel storing section 501 and condensed.

In a power generating system comprising a plurality of the above described fuel containers 500 and a power generating module, the structure and the operation is the same as the above-described power generating system 300, thus, the explanation is omitted.

Next, a case in which a power generating system comprising a first fuel container 500A and a second fuel container 500B which have the same structure as the fuel container 500 and a power generating module is applied to a electronic device 800 is explained. Specifically, the electronic device is a portable device and the system is applied to a laptop personal computer. In the description below, the components of the first fuel container 500A correspond to the components of the above-described fuel container 500, thus an alphabet A will be applied to the same reference numbers, and as for the second fuel container 500B, an alphabet B will be applied to the same reference numbers.

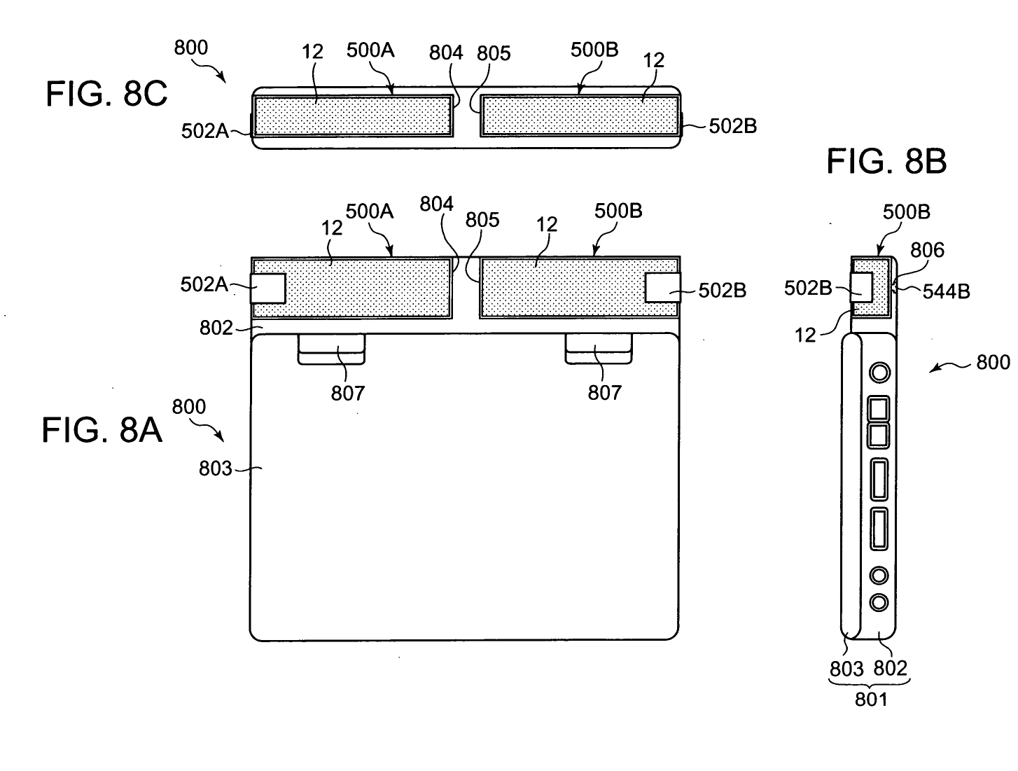

FIG. 8A is a top view of the electronic device 800, FIG. 8B is a right side view of the electronic device 800 of FIG. 8A, and FIG. 8C is a rear view of the electronic device 800 of FIG. 8A.

The electronic device 800 comprises a main body 801 embedded with a processing circuit including a CPU, a RAM, a ROM and other electronic parts, a first fuel container 500A and a second fuel container 500B to store fuel 12 which are removably attached to the main body 801, and a power generating module (not shown) which is provided in the main body 801 and which uses the fuel 12 in the first and second fuel containers 500A and 500B in order to generate power, and the generated electric energy is supplied to the main body 801 in order to drive the main body 801. The structure and the operation of the first and second fuel containers 500A and 500B and the power generating module (not shown) are the same as those described above, thus the description is omitted.

The main body 801 comprises a lower case 802 equipped with a keyboard and an upper case 803 equipped with a liquid crystal display. The upper case 803 is connected to the lower case 802 with a hinge 807. The main body 801 is structured so that it can be folded in a state in which the upper case 803 is laid on the lower case 802 and the liquid crystal display is facing the keyboard. The length from the rear side to the front side of the upper case 803 is shorter than that of the lower case 802 and the main body 801 may be folded so that the end of the upper case 803 is aligned with the end of the case 802 at the front end. Thus, when the upper case 803 is laid on the lower case 802, a portion of an upper surface of the lower case 802 on the rear side is not covered with the upper case 803 and is exposed.

In the exposed areas of the lower case 802, a rectangular first storing space 804, which is open toward the upper surface, the left side surface, and the rear surface and stretches in a horizontal direction, and a rectangular second storing space 805, which is open toward the upper surface, the right side surface, and the rear surface and stretches in a horizontal direction, are formed so as to be symmetric with respect to a central line in a horizontal direction.

The first fuel container 500A may be stored in the first storing space 804 from the left side opening. A rail (not shown) is formed on the left end of the bottom section of the first storing space 804, and the rail engages to a guide (not shown) which is formed on the bottom surface of the first fuel container 500A.

The second fuel container 500B may be stored in the second storing space 805 from the right side opening. A rail 806 is formed on the right end of the bottom section of the second storing space 805, and the rail 806 engages to a guide 544B of the second fuel container 500B.

The first fuel container 500A and the second fuel container 500B are attached to the storing spaces 804 and 80 respectively by sliding the fuel containers 500A and 500B from the end section of the discharge opening and supply opening so that the ends of the gas-liquid separation film 502A and 502B face outward, and engaging the guide 544B to the rail 806.

As described above, the fuel containers 500A and 500B stored in the storing spaces 804 and 805 respectively are attached so that the bottom side is exposed to the outside, thus the bottom side is in direct contact with the outside air so the heat is dissipated well, and the heat is not trapped in the power generating system, which raises the water collection rate.

The present invention is not limited to the above-described embodiments, and the invention can be appropriately modified within a range not departing from its subject matter.

For example, in the above-described embodiment, the power generating system 300 comprises two fuel containers, a first fuel container 100A and 500A and a second fuel container 100B and 500B, however the system may comprise three or more containers.

The shape, etc. of the components in the fuel container 100 and 500 may be appropriately modified. For example, the openings 43, 543a and 543b are rectangular, however the openings may be formed with multiple holes.

In the above-described embodiments, a reactor 210 is provided so that the fuel 12 is reformed and then supplied to the power generating section, which is a fuel cell. However, the power generating module may be a direct-type fuel cell in which the reactor is not provided and the fuel 12 from the first and second fuel containers 100 and 500 may be directly supplied to the fuel cell.

The entire disclosure of Japanese Patent Application No. 2006-304801 on Nov. 10, 2006 including specification, claims, drawings and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A power generating module which generates electric power by using fuel, comprising:
an accommodating section to accommodate a fuel container to store fuel;
a power generating section to perform power generation by using the fuel in the fuel container; and
a controlling section to allow, after an amount of the fuel in the fuel container accommodated in the accommodating section becomes less than a predetermined amount necessary for the power generation in the power generating section, at least a portion of a by-product generated in a process of the power generation in the power generating section to be collected into the fuel container containing less than the predetermined amount of the fuel.

2. The power generating module according to claim 1, wherein the controlling section allows the by-product collected in the fuel container to be supplied to the power generating section for the power generation in the power generating section.

3. The power generating module according to claim 1, further comprising a collector to collect the by-product generated by the power generation,
wherein the controlling section allows a surplus portion of the by-product from the collector to be collected into the fuel container containing less than the predetermined amount necessary for the power generation.

4. The power generating module according to claim 1, wherein the fuel container containing less than the predetermined amount necessary for the power generation is substantially empty.

5. The power generating module according to claim 1, further comprising a reacting section to reform the fuel of the fuel container.

6. The power generating module according to claim 1, wherein the controlling section prevents at least the portion of the by-product from being collected into the fuel container until the amount of the fuel in the fuel container becomes less than the predetermined amount.

7. An electronic device, comprising:
the power generating module of claim 1.

8. A power generating module which generates electric power by using fuel, comprising:
an accommodating section to accommodate a plurality of fuel containers to store fuel;
a power generating section to perform power generation by using the fuel in the fuel containers; and
a controlling section to allow, after an amount of the fuel in one of the plurality of fuel containers accommodated in the accommodating section becomes less than a predetermined amount necessary for the power generation in the power generating section, at least a portion of a by-product generated in a process of the power generation in the power generating section to be collected into the one of the plurality of fuel containers containing less than the predetermined amount of the fuel.

9. The power generating module according to claim 8, wherein the controlling section allows the by-product collected in the fuel container to be supplied to the power generating section for the power generation in the power generating section.

10. The power generating module according to claim 8, further comprising a collector to collect the by-product generated by the power generation,
wherein the controlling section allows a surplus portion of the by-product from the collector to be collected into the fuel container containing less than the predetermined amount necessary for the power generation.

11. The power generating module according to claim 8, wherein the fuel container containing less than the predetermined amount necessary for the power generation is substantially empty.

12. The power generating module according to claim 8, further comprising a reacting section to reform the fuel of the fuel container.

13. The power generating module according to claim 8, wherein the controlling section prevents at least the portion of the by-product from being collected into any of the plurality of fuel containers until the amount of the fuel in one of the plurality of fuel containers becomes less than the predetermined amount.

14. An electronic device, comprising:
the power generating module of claim 8.
